(19) United States
(12) Patent Application Publication
(10) Pub. No.: US 2011/0279078 A1
(43) Pub. Date: Nov. 17, 2011

(54) Charging circuit and method, electronic device, and power supply unit

(75) Inventors: Yasushi Hara, Kawasaki (JP); Yuki Tamura, Kawasaki (JP); Koichi Hiramoto, Kawasaki (JP)

(73) Assignee: FUJITSU LIMITED, Kawasaki (JP)

(21) Appl. No.: 13/067,161

(22) Filed: May 12, 2011

Related U.S. Application Data
(63) Continuation of application No. PCT/JP2008/070752, filed on Nov. 14, 2008.

(51) Int. Cl. H02J 7/04; H02J 7/00

(52) U.S. Cl. 320/107; 320/162

(57) ABSTRACT

A charging circuit configured to charge a rechargeable battery includes an input unit configured to support forms of connection to an external power supply and to receive electric power supplied from the external power supply; a charge unit configured to supply the rechargeable battery with the electric power supplied from the input unit; a detection unit configured to detect the charge level of the rechargeable battery; and a charge control unit configured to control the charge unit so as to prevent the rechargeable battery from being supplied with the electric power supplied from the input unit supplied with the electric power from the external power supply through one of the forms of connection to the external power supply, in response to the charge level detected by the detection unit exceeding a threshold corresponding to the one of the forms of connection.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2008/070752, filed on Nov. 14, 2008, the entire contents of which are incorporated herein by reference.

### FIELD

A certain aspect of the embodiments discussed herein is related to a charging circuit for a rechargeable battery.

### BACKGROUND

Conventionally, in mobile electronic devices such as cellular phones and notebook personal computers (PC) containing a rechargeable battery, the electronic devices continue and repeat charging their batteries until the batteries are charged up to their maximum chargeable capacities (fully charged) once the electronic devices are connected to an AC/DC conversion adapter for charging.

The maximum chargeable capacities of rechargeable batteries gradually decrease as the rechargeable batteries are used for a long period of time. In general, it is believed that the rechargeable batteries are determined as reaching the ends of their useful service lives when it is no longer possible to ensure practically sufficient charging capacities.

Some known charging units of portable communications devices have multiple adapter connection terminals that allow connections of multiple kinds of charging adapters different in specifications; multiple charging paths from these multiple kinds of adapter connection terminals to a rechargeable battery; and a central processing unit (CPU) configured to obtain information on a charging adapter connected to each adapter connection terminal and to select one of the charging paths and determine a charging control method based on information on the specifications of the connected charging adapter.

Some known portable terminal units are configured to use a rechargeable battery as a power supply, and have a housing unit including multiple housings and a connecting unit configured to connect the housings so that the housings may be opened and closed relative to each other; an open/closed state detecting unit configured to detect the open/closed state of the housing unit; a charging circuit configured to feed electric power from an external power supply to the secondary battery; and a charging control circuit configured to control the charging circuit based on the detection result of the open/closed state detecting unit.

According to a known method of charging a portable electronic device, when the portable electronic device is connected to a power source, the method selects a protection mode or a rapid charging mode in order to charge a battery in accordance with the current operating state of the portable electronic device, and at the same time, the battery power is controlled to a safe range. As a result, the battery of the portable electronic device may be charged at high speed without affecting device efficiency. Further, the battery is protected from overcharge, so that the battery may have a longer useful service life.

For the related art, reference may be made to, for example, Japanese Laid-Open Patent Application No. 2004-336951, Japanese Laid-Open Patent Application No. 2007-129392, and Japanese Laid-Open Patent Application No. 2008-43186.

### SUMMARY

According to an aspect of the invention, a charging circuit configured to charge a rechargeable battery includes an input unit configured to support a plurality of forms of connection to an external power supply and to receive electric power supplied from the external power supply; a charge unit configured to supply the rechargeable battery with the electric power supplied from the input unit; a detection unit configured to detect a charge level of the rechargeable battery; and a charge control unit configured to control the charge unit so as to prevent the rechargeable battery from being supplied with the electric power supplied from the input unit supplied with the electric power from the external power supply through one of the forms of connection to the external power supply, in response to the charge level detected by the detection unit exceeding a threshold corresponding to the one of the forms of connection.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a schematic diagram illustrating a charging-related configuration of an electronic device and three kinds of modes of connection between a power supply circuit in the electronic device and an alternating current-direct current (AC/DC) conversion adapter for charging and a USB cable according to a first embodiment;

FIG. 2 is a schematic diagram illustrating the power supply circuit implemented as an integrated circuit according to the first embodiment;

FIG. 3 is a diagram illustrating two different kinds of possible modes of connection between the power supply circuit in the electronic device and the AC/DC conversion adapter according to the first embodiment;

FIG. 4 is a diagram illustrating three different kinds of possible modes of connection between the power supply circuit in the electronic device and the AC/DC conversion adapter and a USB cable according to a second embodiment, which is a variation of the embodiment illustrated in FIG. 3;

FIG. 5 is a diagram illustrating two different kinds of possible modes of connection between the power supply circuit in the electronic device and the AC/DC conversion adapter according to a third embodiment, which is another variation of the embodiment illustrated in FIG. 3;

FIG. 6 is a diagram illustrating two different kinds of possible modes of connection between the power supply circuit in the electronic device and the AC/DC conversion adapter according to a fourth embodiment, which is another variation of the embodiment illustrated in FIG. 3 or FIG. 5;

FIGS. 7A through 7D are diagrams illustrating charge level setting screens displayed on a display unit 108 of the electronic device;

FIGS. 8A and 8B are flowcharts illustrating charge control executed by a charge control unit of the power supply circuit;

FIG. 9 illustrates (a) a flowchart of a display operation in the display unit at the start of charging, which is executed by a CPU of the electronic device in accordance with a power supply managing function in an application and (b) a screen displayed on the display unit in the illustrated display operation; and

FIG. 10 illustrates (a) a flowchart of a display operation in the display unit at the end of charging, which is executed by the CPU of the electronic device in accordance with the power supply managing function in the application and (b) a screen displayed on the display unit in the illustrated display operation.

### DESCRIPTION OF EMBODIMENTS

The inventors of the present invention have recognized that when a user keeps a constant connection between the rechargeable battery of an electronic device and an AC/DC conversion charger adapter, and uses the electronic device with the rechargeable battery nearly fully charged (nearly in its maximum charged state) to cause the rechargeable battery to be charged and discharged repeatedly at frequent intervals between the fully-charged state and a state where the rechargeable battery is slightly less charged than in the fully-charged state, the maximum chargeable level of the rechargeable battery decreases relatively greatly in a short period of time, so that the useful service life of the rechargeable battery is reduced. Further, the inventors have recognized that by charging the rechargeable battery at most to a level lower by a given proportion than the fully-charged state, it is possible to reduce the rate of decrease of the maximum chargeable level of the rechargeable battery and thus to prolong the useful service life of the rechargeable battery.

According to an aspect of the invention, the rechargeable battery may have a longer useful service life.

According to an aspect of the invention, a decrease in the maximum chargeable level of the rechargeable battery may be prevented or reduced.

Preferred embodiments of the present invention will be explained with reference to accompanying drawings. In the drawings, the same components are referred to by the same reference numerals.

### [a] First Embodiment

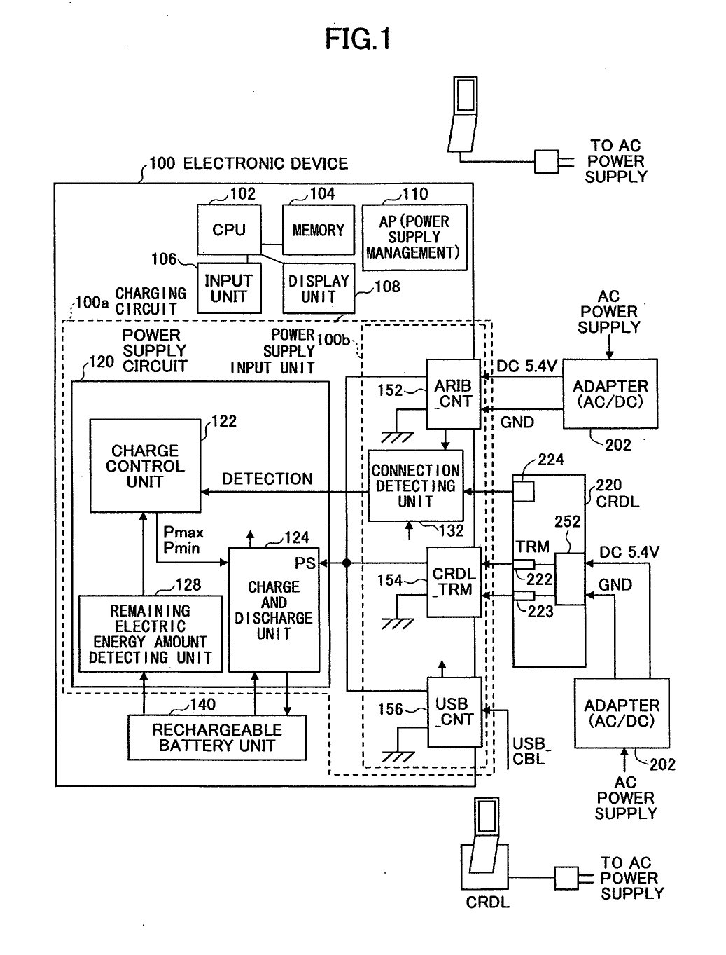

FIG. 1 is a schematic diagram illustrating a charging-related configuration of an electronic device 100 and three kinds of modes of connection between a power supply circuit 120 in the electronic device 100 and an alternating current-direct current (AC/DC) conversion adapter 202 for charging and a USB cable (USB_CBL) according to a first embodiment.

Examples of the electronic device 100 include a cellular phone, an ultra-mobile personal computer, and a personal digital assistant (PDA).

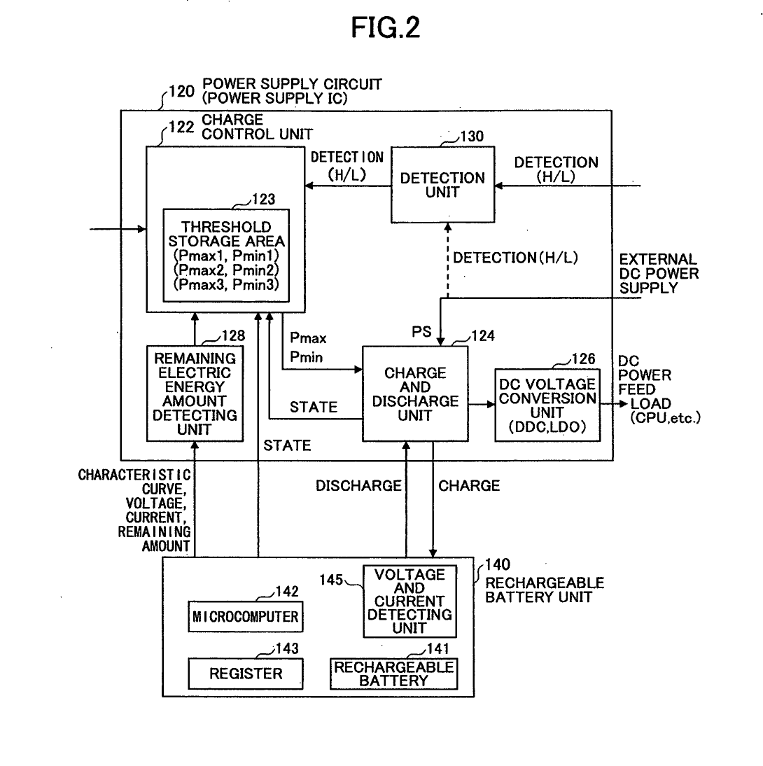

The electronic device 100 includes the power supply circuit 120; a detachable and reattachable rechargeable battery unit 140 including a rechargeable battery 141 (FIG. 2), such as a lithium ion rechargeable battery pack; a connection detecting unit (a connection form [type] detecting unit) 132; an ARIB (Association of Radio Industries and Businesses) connector (ARIB_CNT) 152 of an ARIB standard, and a cradle terminal unit (CRDL_TRM) 154.

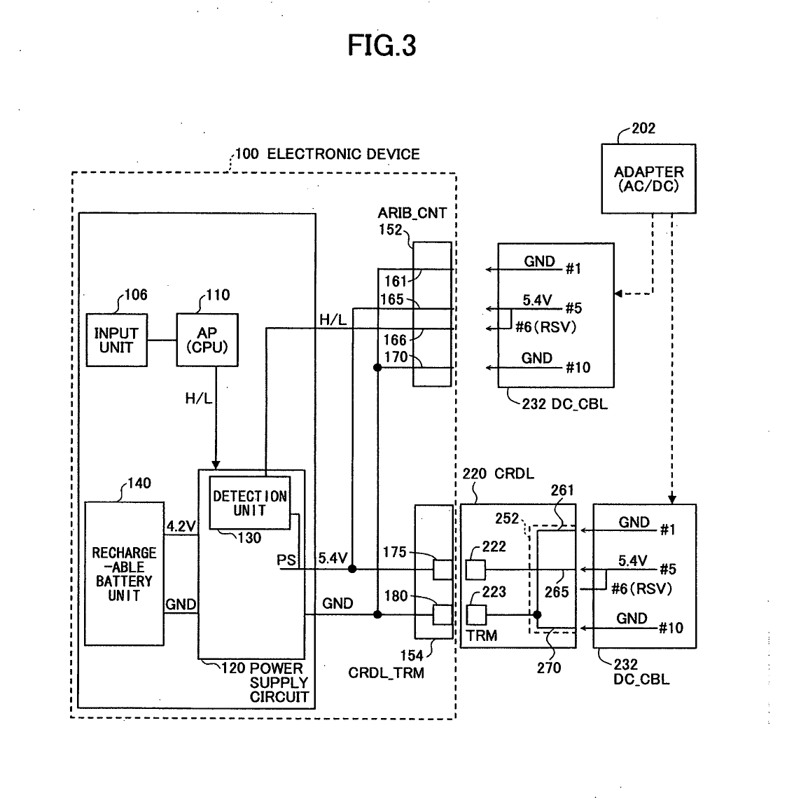

The connection detecting unit 132 detects (identifies) the presence or absence of a connection with a cable connector (DC_CBL) 232 (FIG. 3) of the AC/DC conversion adapter 202 and/or a cradle for charging (charging cradle) (CRDL) 220.

The ARIB connector 152 is connected to the cable connector 232 of the AC/DC conversion adapter 202. The cradle terminal unit 154 is connected to a power feed terminal (TRM) 222 of the charging cradle 220. The electronic device 100 may further include a universal serial bus (USB) connector (USB_CNT) 156 configured to be connected to, for example, a desktop personal computer (PC) or the like.

In the electronic device 100, the power supply circuit 120, the connection detecting unit 132, the ARIB connector 152, the cradle terminal unit 154, and the USB connector 156 may be considered as forming a charging circuit 100a. Further, the connection detecting unit 132, the ARIB connector 152, the cradle terminal unit 154, and the USB connector 156 may be considered as forming a power supply input unit for an external power supply (an input unit) 100b in the charging circuit.

The electronic device 100 further includes a CPU 102 configured to execute applications of various functions, a memory 104 configured to contain programs such as applications and data, an input unit 106 including, for example, a keyboard and keys or buttons, and a display unit 108 such as a liquid crystal display (LCD). The memory 104 includes a random access memory (RAM) and a nonvolatile storage device such a flash memory.

The charging cradle 220 includes the power feed terminal 222, a ground terminal (TRM) 223, an indicator 224 configured to indicate the presence of the cradle 220 with, for example, a magnetic field or voltage, and an ARIB connector 252 connected to the cable connector 232 (FIG. 3) of the AC/DC conversion adapter 202.

The connection detecting unit 132 of the electronic device 100 is, for example, a conductor and/or a sensor. The conductor is configured to capture a high-level or low-level (H/L) voltage from the AC/DC conversion adapter 202, the cradle 220 or the like, and to connect the captured voltage to a charge control unit 122 (described below) of the power supply circuit 120. The sensor is configured to detect the presence or absence (H/L) indicated by the indicator 224 of the cradle 220, and to connect a signal indicating the detection result to the charge control unit 122. The sensor may be, for example, a magnetic sensor (such as a Hall integrated circuit [IC] containing a magnetoresistive [MR] sensor) configured to detect the presence or absence (H/L) of a magnetic field of a permanent magnet as the indicator 224.

One method of connecting the AC/DC conversion adapter 202 to the electronic device 100 for charging is to directly connect the AC/DC conversion adapter 202 to the ARIB connector 152 of the electronic device 100. Another method of connecting the AC/DC conversion adapter 202 to the electronic device 100 is to connect the AC/DC conversion adapter 202 to the cradle 220 and place the electronic device 100 in the cradle 220, thereby connecting the AC/DC conversion adapter 202 to the cradle terminal unit 154 of the electronic device 100 via the cradle 220. Yet another method of supplying the electronic device 100 with DC voltage is to connect a USB cable connected to a personal computer to the USB connector 156 of the electronic device 100.

Referring to FIG. 1, the charge control unit 122 of the electronic device 100 receives information (Ah) representing the amount of remaining electric energy (electric power) of the rechargeable battery unit 140 constantly or repetitively detected or calculated by a remaining electric energy amount detecting unit 128 of the power supply circuit 120.

Here, referring to FIG. 2, the rechargeable battery unit 140 includes the rechargeable battery 141 (BAT), a microcomputer (microprocessor) 142, a register 143 (RG), and a voltage and current (V & I) detecting unit 145. The voltage and current detecting unit 145 may be included in a charge and discharge unit 124 (described below) of the power supply circuit 120.

The microprocessor 142 is configured to detect the value of a voltage supplied by the rechargeable battery 141, calculate a currently available amount of remaining electric energy in accordance with the detected voltage value based on a voltage-remaining electric energy amount characteristic (a curve or table) in the register 143, and output the calculated currently available amount of remaining electric energy to the remaining electric energy amount detecting unit 128. As an alternative configuration, the microprocessor 142 may be configured to output the detected voltage value to the remaining electric energy amount detecting unit 128, and the remaining electric energy amount detecting unit 128 may be configured to calculate a currently available amount of remaining electric energy in accordance with the detected voltage value based on the voltage-remaining electric energy amount characteristic (curve or table).

If the AC/DC conversion adapter 202 is directly connected to the ARIB connector 152 of the electronic device 100 when the amount of remaining electric energy of the rechargeable battery unit 140 is less than a predetermined minimum proportion Pmin (for example, 90%) of the maximum chargeable capacity (full-charge level) (for example, 800 mAh), the charge and discharge unit 124 of the power supply circuit 120 supplies the rechargeable battery unit 140 with direct electric current or electric power from the AC/DC conversion adapter 202 under the control of the charge control unit 122. Under the control of the charge control unit 122, the charge and discharge unit 124 stops feeding the rechargeable battery unit 140 if the detected amount of remaining electric energy from the remaining electric energy amount detecting unit 128 reaches a predetermined maximum proportion Pmax (for example, 100%) of the maximum chargeable capacity.

The connection detecting unit 132 is configured to electrically or magnetically detect a connection of the electronic device 100 and the cradle 220 when the electronic device 100 is placed in the cradle 220. The charge control unit 122 receives a detection signal (H/L) indicating the presence or absence of the connection. If the AC/DC conversion adapter 202 is connected to the cradle 220 and the electronic device 100 is placed in the cradle 220 so that the power feed terminal 222 of the cradle 220 comes into contact with and connects to the cradle terminal unit 154 of the electronic device 100 when the amount of remaining electric energy of the rechargeable battery unit 140 is less than a predetermined minimum proportion Pmin (for example, 70%) of the maximum chargeable capacity, the charge and discharge unit 124 of the power supply circuit 120 supplies the rechargeable battery unit 140 with direct electric current or electric power from the AC/DC conversion adapter 202 via the cradle 220 under the control of the charge control unit 122. If the charge control unit 122 determines that the detected amount of remaining electric energy from the remaining electric energy amount detecting unit 128 reaches a predetermined maximum proportion Pmax (for example, 80%) of the maximum chargeable capacity, the charge control unit 122 controls the charge and discharge unit 124 so that the charge and discharge unit 124 stops feeding the rechargeable battery unit 140. Thereby, it is possible to prevent the rechargeable battery unit 140 from being fully charged (charged to its full capacity) (100%), so that it is possible to prolong the useful service life of the rechargeable battery unit 140.

FIG. 2 is a schematic diagram illustrating the power supply circuit 120 implemented as an integrated circuit (IC).

Referring to FIG. 2, the power supply circuit 120 includes the charge control unit 122, the charge and discharge unit 124, a direct-current (DC) voltage conversion unit 126, the remaining electric energy amount detecting unit 128, and a detection unit 130. The DC voltage conversion unit 126 is configured to supply electric power of a predetermined voltage to a component load such as the CPU 102 by converting received voltage. The detection unit 130 is configured to detect a voltage and a signal related to an external direct-current power supply such as the AC/DC conversion adapter 202, the cradle 220, or a USB cable.

The charge control unit 122 includes a threshold storage area 123. The threshold storage area 123 retains threshold values that represent applicable predetermined maximum proportion Pmax and minimum proportion Pmin, respectively, of the amount of remaining electric energy for controlling the operation of the charge and discharge unit 124. Such threshold values (maximum and minimum charge levels), which may also be expressed as Pmax and Pmin, may be, for example, 80% and 70%. The threshold values Pmax and Pmin may be set through an application (AP) 110 (a charge level setting function) (FIG. 1) that operates on the CPU 102 of the electronic device 100 by a user using the input unit 106, and be stored in the memory 104 or the threshold storage area 123 of the charge control unit 122. The application 110 also may be contained in the memory 104.

The detection unit 130 is configured to detect the presence or absence (H/L) of a connection between the electronic device 100 and the AC/DC conversion adapter, the cradle 220, and/or a USB cable as an external direct-current power supply, and to provide the charge control unit 122 with a detection signal. Further, the detection unit 130 is configured to detect the presence or absence (H/L) of a charging voltage from such an external direct-current power supply, and to provide the charge control unit 122 with a detection signal.

The DC voltage conversion unit 126 includes, for example, a direct current-to-direct current (DC/DC) voltage converter (DDC) and a low dropout (LDO) regulator. The DC voltage conversion unit 126 is configured to, for example, covert a direct-current voltage (for example, 4.2 V) from the charge and discharge unit 124 into a required low direct-current voltage (for example, 3.3 V or 1.2 V), and to supply the loads of components of the electronic device 100 (such as the CPU 102, the memory 104, and the display unit 108) with electric power.

The charge and discharge unit 124 is configured to receive electric current from an external direct-current power supply to charge the rechargeable battery unit 140 and to supply the DC voltage conversion unit 126 with a discharge current from the rechargeable battery unit 140 in accordance with the command of the charge control unit 122.

The voltage and current detecting unit 145 of the rechargeable battery unit 140 is configured to detect voltage and current values, a current direction, etc., in the feeding of electric power by and the charging of the rechargeable battery 141. The microprocessor 142 of the rechargeable battery unit 140 or the charge and discharge unit 124 of the power supply circuit 120 is configured to determine the state of charging and/or the state of discharging of the rechargeable battery 141 based on the detected values from the voltage and current detecting unit 145, and to feed the determination information to the charge control unit 122.

FIG. 3 is a diagram illustrating two different kinds of possible modes of connection (forms of connection) between the power supply circuit 120 in the electronic device 100 and the AC/DC conversion adapter 202 according to this embodiment.

Of Terminals (Pins) #1 through #10, the direct-current cable connector (DC_CBL) 232 of the AC/DC conversion adapter 202 has Ground Terminal #1 (GND), Power Feed Terminal #5 (5.4 V), Reserve Terminal #6 (RSV) connected to Power Feed Terminal #5, and Ground Terminal #10. Here, Reserve Terminal #6 is used as an indicator to indicate the presence of the cable connector 232.

The ARIB connector 152 of the electronic device 100 has a ground terminal 161 to be connected to Ground Terminal #1 of the cable connector 232, a power feed terminal 165 to be connected to Power Feed Terminal #5 (5.4 V) of the cable connector 232, a cable connector detecting terminal 166 to be connected to Reserve Terminal #6 (RSV) of the cable connector 232, and a ground terminal 170 to be connected to Ground Terminal #10 of the cable connector 232. The ground terminals 161 and 170 are connected inside the electronic device 100 to be connected to the ground input terminal of the power supply circuit 120. The power feed terminal 165 is connected to the power supply input terminal PS (of the charge and discharge unit 124) of the power supply circuit 120. The cable connector detecting terminal 166 is connected to the detection unit 130 of the power supply circuit 120.

The ARIB connector 252 of the cradle 220 has a ground terminal 261 to be connected to Ground Terminal #1 of the cable connector 232, a power feed terminal 265 to be connected to Power Feed Terminal #5 (5.4 V) of the cable connector 232, and a ground terminal 270 to be connected to Ground Terminal #10 of the cable connector 232. The cradle 220 has a contact terminal 222 for power feeding connected to the power feed terminal 265 and a contact terminal 223 for grounding connected to the ground terminals 261 and 270.

The cradle terminal unit 154 of the electronic device 100 has a contact terminal 175 to be put in contact with and connected to the contact terminal 222 of the cradle 220 and a contact terminal 180 to be put in contact with and connected to the contact terminal 223 of the cradle 220. The contact terminal 175 is connected to the power supply input terminal PS (5.4 V) (of the charge and discharge unit 124) of the power supply circuit 120. The ground terminal 180 is connected to the ground input terminal of the power supply circuit 120.

It is assumed that the cable connector 232 of the AC/DC conversion adapter 202 is directly connected to the ARIB connector 152 of the electronic device 100 when the amount of remaining electric energy of the rechargeable battery unit 140 is not 100% (full) and is less than a first minimum proportion Pmin1 (for example, 90%, 85%, or 80%) of the maximum chargeable capacity (for example, 800 mAh). Then, the detection unit 130 of the power supply circuit 120 detects a high voltage level H (5.4 V) at Reserve Terminal #6 of the cable connector 232 via the cable connector detecting terminal 166, and provides the charge control unit 122 with a signal (H) indicating detection of the connection of the cable connector 232. The detection unit 130 or the charge and discharge unit 124 may further detect a supply voltage (for example, 5.4 V) from the power feed terminal 165 at the power supply input terminal PS and provide the charge control unit 122 with a signal (H/L) indicating the presence of a charging voltage.

The charge control unit 122 of the power supply circuit 120 determines, in response to detection of the connection of the cable connector 232 and/or detection of the presence of a charging voltage, that the AC/DC conversion adapter 202 has been directly connected to the ARIB connector 152 of the electronic device 100.

In accordance with the determination, the charge control unit 122 causes the charge and discharge unit 124 to charge the rechargeable battery unit 140 up to a first maximum proportion Pmax1 (for example, 100%, 95%, or 90%) of the maximum chargeable capacity. Thereafter, irrespective of the presence or absence of the connection of the electronic device 100 and the cable connector 232, the charge control unit 122 stops charging and prevents charging from being started until the amount of remaining electric energy of the rechargeable battery unit 140 is reduced to the first minimum proportion Pmin1 of the maximum chargeable capacity. This makes it possible to prevent or reduce frequently charging the rechargeable battery unit 140 to its full level (100%), so that it is possible to prolong the useful service life of the rechargeable battery unit 140. As an alternative configuration, instead of setting the first minimum proportion Pmin1, the rechargeable battery unit 140 may be charged as much as possible in response to even a slight drop in the amount of remaining electric energy of the rechargeable battery unit 140 from its full level as usual.

On the other hand, it is assumed that the AC/DC conversion adapter 202 is connected to the cradle 220 and the electronic device 100 is placed in the cradle 220 so that the contact terminals 222 and 223 of the cradle 220 contact and connect to the contact terminals 175 and 180, respectively, of the cradle terminal unit 154 of the electronic device 100 when the amount of remaining electric energy of the rechargeable battery unit 140 is not 100% and is less than a second minimum proportion Pmin2 (for example, 80%) of the maximum chargeable capacity. Then, the detection unit 130 of the power supply circuit 120 detects a supply voltage (for example, 5.4 V) from the contact terminal 175 for power feeding at the power supply input terminal PS and provides the charge control unit 122 with a signal (H) indicating the presence of a charging voltage. The detection unit 130 of the power supply circuit 120 further detects a low voltage level L (0 V) at the cable connector detecting terminal 166 and provides the charge control unit 122 with a signal (L) indicating no detection of the connection of the cable connector 232.

The charge control unit 122 of the power supply circuit 120 determines, in response to detection of the presence of a charging voltage and detection of the absence of the connection of the cable connector 232, that the cradle 220 in an active state (a state where the cradle 220 is enabled to feed power) has been directly put in contact with and connected to the cradle terminal unit 154 of the electronic device 100.

In accordance with this determination, the charge control unit 122 causes the charge and discharge unit 124 to charge the rechargeable battery unit 140 up to a second maximum proportion Pmax2 (for example, 80%) of the maximum chargeable capacity. Thereafter, irrespective of the presence or absence of the connection of the electronic device 100 and the cradle 220, the charge control unit 122 stops charging and prevents charging from being started until the amount of remaining electric energy of the rechargeable battery unit 140 is reduced to the second minimum proportion Pmin2 of the maximum chargeable capacity. This makes it possible to prevent the rechargeable battery unit 140 from being fully charged, so that it is possible to prolong the useful service life of the rechargeable battery unit 140.

### [b] Second Embodiment

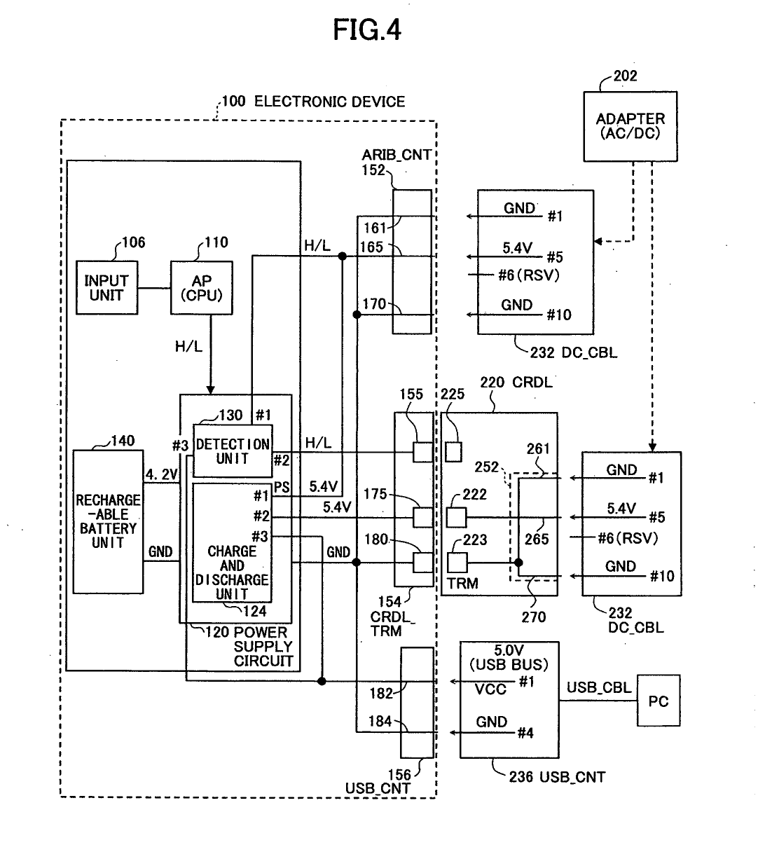

FIG. 4 is a diagram illustrating three different kinds of possible modes of connection between the power supply circuit 120 in the electronic device 100 and the AC/DC conversion adapter 202 and a USB connector (USB_CNT) 236 (a USB cable) according to a second embodiment, which is a variation of the embodiment illustrated in FIG. 3.

Like in the case of FIG. 3, the cable connector 232 of the AC/DC conversion adapter 202 has, of Terminals (Pins) #1 through #10, Ground Terminal #1 (GND), Power Feed Terminal #5 (5.4 V), and Ground Terminal #10. Here, Reserve Terminal #6 is used as an indicator to indicate the presence of the cable connector 232. In this case, Reserve Terminal #6 (RSV) of the AC/DC conversion adapter 202 is not used.

In this case, like in the case of FIG. 3, the ARIB connector 152 of the electronic device 100 has the ground terminal 161, the power feed terminal 165, and the ground terminal 170. The power feed terminal 165 is connected to a power supply input terminal PS#1 of the power supply circuit 120 and to the detection unit 130 (#1). The cable connector detecting terminal 166 of FIG. 3 is not used.

In addition to the ground terminal 261, the power feed terminal 265, the ground terminal 270, and the contact terminals 222 and 223, which are the same as in the case of FIG. 3, the cradle 220 has a permanent magnet 225 configured to indicate the presence of the cradle 220.

In addition to the contact terminals 175 and 180, the cradle terminal unit 154 of the electronic device has a magnetic sensor 155 configured to detect the presence or absence of the permanent magnet 225 of the cradle 220 and to output a detection signal (H/L). The magnetic sensor 155 has a detection terminal connected to the detection unit 130 (#2) of the power supply circuit 120. The contact terminal 175 for power feeding is connected to a power supply input terminal PS#2 of the charge and discharge unit 124 of the power supply circuit 120.

A USB cable USB_CBL having one end connected to, for example, a desktop personal computer (PC) or the like is used for charging. The USB cable USB CBL has the USB connector 236 at the other end. The USB connector 236 has a USB-bus power feed terminal #1 (5.0 V) and a ground terminal #4 (GND).

The electronic device 100 includes the USB connector 156, which may be usable for at least charging. The USB connector 156 has a power feed terminal 182 and a ground terminal 184. The power feed terminal 182 is connected to the USB-bus power feed terminal #1 of the USB connector 236 and to a power supply input terminal PS#3 of the charge and discharge unit 124 and the detection unit 130 (#3) of the power supply circuit 120. The ground terminal 184 is connected to the ground terminal #4 of the USB connector 236 and to the ground terminal GND of the power supply circuit 120.

The detection unit 130 (#1) of the power supply circuit 120 is connected to the power feed terminal 165 of the ARIB connector 152 to detect the presence or absence (H/L) of the connection of the ARIB connector 152 and the cable connector 232. Further, the detection unit (#2) is connected to the magnetic sensor 155 to detect the presence or absence (H/L) of the connection of the cradle terminal unit 154 and the cradle 220. Further, the detection unit 130 (#3) is connected to the power feed terminal 182 of the USB connector 156 to detect the presence or absence (H/L) of the connection of the USB connector 156 and the USB connector 236.

It is assumed that the cable connector 232 of the AC/DC conversion adapter 202 is directly connected to the ARIB connector 152 of the electronic device 100 when the amount of remaining electric energy of the rechargeable battery unit 140 is not 100% and is less than a first minimum proportion Pmin1 (for example, 90%, 85%, or 80%) of the maximum chargeable capacity. Then, the detection unit 130 of the power supply circuit 120 detects a high voltage level H (5.4 V) at Power Feed Terminal #5 of the cable connector 232 via the power feed terminal 165, and provides the charge control unit 122 with a signal (H) indicating detection of the connection of the cable connector 232. The detection unit 130 or the charge and discharge unit 124 may further detect a supply voltage (for example, 5.4 V) from the power feed terminal 165 at the power supply input terminal PS#1 and provide the charge control unit 122 with a signal (H/L) indicating the presence of a charging voltage.

The charge control unit 122 of the power supply circuit 120 determines, in response to detection of the connection of the cable connector 232 and/or detection of the presence of a charging voltage, that the AC/DC conversion adapter 202 has been directly connected to the ARIB connector 152 of the electronic device 100.

In accordance with the determination, the charge control unit 122 causes the charge and discharge unit 124 to charge the rechargeable battery unit 140 up to a first maximum proportion Pmax1 of the maximum chargeable capacity. Thereafter, irrespective of the presence or absence of the connection of the electronic device 100 and the cable connector 232, the charge control unit 122 stops charging and prevents charging from being started until the amount of remaining electric energy of the rechargeable battery unit 140 is reduced to the first minimum proportion Pmin1 of the maximum chargeable capacity. This makes it possible to prevent the rechargeable battery unit 140 from being fully charged frequently, so that it is possible to prolong the useful service life of the rechargeable battery unit 140. As an alternative configuration, instead of setting the first minimum proportion Pmin1, the rechargeable battery unit 140 may be charged as much as possible in response to even a slight drop in the amount of remaining electric energy of the rechargeable battery unit 140 from its full level as usual.

On the other hand, it is assumed that the AC/DC conversion adapter 202 is connected to the cradle 220 and the electronic device 100 is placed in the cradle 220 so that the contact terminals 222 and 223 of the cradle 220 contact and connect to the contact terminals 175 and 180, respectively, of the cradle terminal unit 154 of the electronic device 100 when the amount of remaining electric energy of the rechargeable battery unit 140 is not 100% and is less than a second minimum proportion Pmin2 (for example, 80%) of the maximum chargeable capacity. Then, the detection unit 130 of the power supply circuit 120 detects a detection signal (H) of the permanent magnet 225 indicating the presence of the connection of the cradle 220, detected by the magnetic sensor 155, and provides the charge control unit 122 with a detection signal (H) indicating the connection of the cradle 220. The detection unit 130 or the charge and discharge unit 124 may further detect a supply voltage (for example, 5.4 V) from the power feed terminal 175 at the power supply input terminal PS#2 and provide the charge control unit 122 with a signal (H) indicating the presence of a charging voltage.

The charge control unit 122 of the power supply circuit 120 determines, in response to detection of the connection of the cradle 220 and/or detection of the presence of a charging voltage, that the cradle 220 has been put in contact with and connected to the cradle terminal unit 154 of the electronic device 100.

In accordance with this determination, the charge control unit 122 causes the charge and discharge unit 124 to charge the rechargeable battery unit 140 up to a second maximum proportion Pmax2 (for example, 80%) of the maximum chargeable capacity. Thereafter, irrespective of the presence or absence of the connection of the electronic device 100 and the cradle 220, the charge control unit 122 stops charging and prevents charging from being started until the amount of remaining electric energy of the rechargeable battery unit 140 is reduced to the second minimum proportion Pmin2 of the maximum chargeable capacity. This makes it possible to prevent the rechargeable battery unit 140 from being fully charged, so that it is possible to prolong the useful service life of the rechargeable battery unit 140.

Further, It is assumed that the USB connector 236 connected to a USB terminal of a personal computer PC or the like is directly connected to the USB connector 156 of the electronic device 100 when the amount of remaining electric energy of the rechargeable battery unit 140 is not 100% and is less than a third minimum proportion Pmin1 (for example, 85%, 80%, or 75%) of the maximum chargeable capacity. Then, the detection unit 130 of the power supply circuit 120 detects a high voltage level H (5.4 V) at the power feed terminal #1 of the USB connector 236 via the power feed terminal 182, and provides the charge control unit 122 with a signal (H) indicating detection of the connection of the USB connector 236. The detection unit 130 or the charge and discharge unit 124 may further detect a supply voltage (for example, 5.0 V) from the power feed terminal 182 at the power supply input terminal PS#3 and provide the charge control unit 122 with a signal (H/L) indicating the presence of a charging voltage.

The charge control unit 122 of the power supply circuit 120 determines, in response to detection of the connection of the USB connector 236 and/or detection of the presence of a charging voltage, that the USB connector 236 has been connected to the USB connector 156 of the electronic device 100.

In accordance with the determination, the charge control unit 122 causes the charge and discharge unit 124 to charge the rechargeable battery unit 140 up to a third maximum proportion Pmax3 of the maximum chargeable capacity. Thereafter, irrespective of the presence or absence of the connection of the electronic device 100 and the USB connector 236, the charge control unit 122 stops charging and prevents charging from being started until the amount of remaining electric energy of the rechargeable battery unit 140 is reduced to the third minimum proportion Pmin3 of the maximum chargeable capacity. This makes it possible to prevent the rechargeable battery unit 140 from being fully charged, so that it is possible to prolong the useful service life of the rechargeable battery unit 140.

### [c] Third Embodiment

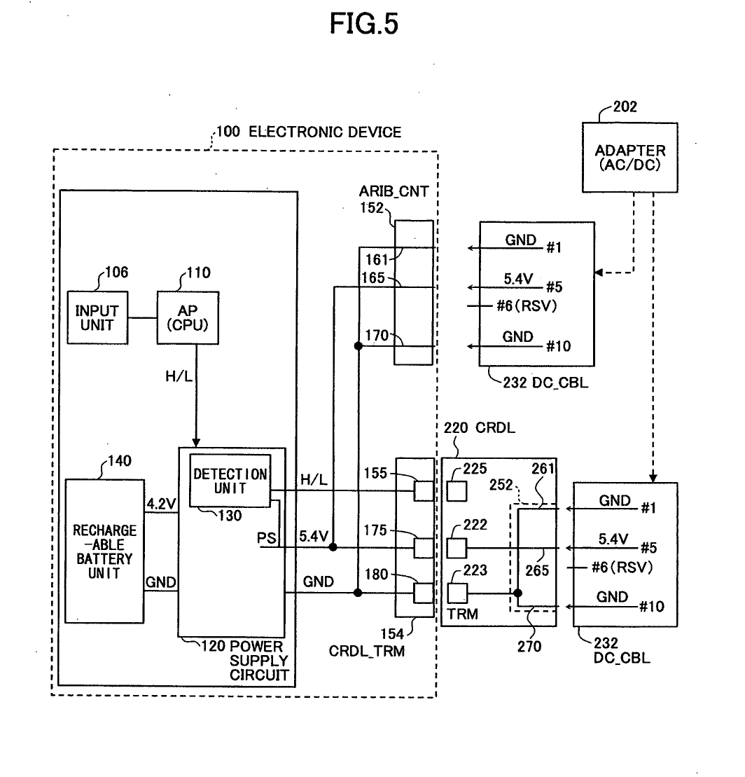

FIG. 5 is a diagram illustrating two different kinds of possible modes of connection between the power supply circuit 120 in the electronic device 100 and the AC/DC conversion adapter 202 according to a third embodiment, which is another variation of the embodiment illustrated in FIG. 3.

Like in the case of FIG. 3, the cable connector 232 of the AC/DC conversion adapter 202 has, of Terminals (Pins) #1 through #10, Ground Terminal #1 (GND), Power Feed Terminal #5 (5.4 V), and Ground Terminal #10. Here, Reserve Terminal #6 is used as an indicator to indicate the presence of the cable connector 232. In this case, Reserve Terminal #6 (RSV) of the AC/DC conversion adapter 202 is not used.

In this case, like in the case of FIG. 3 and the case of FIG. 4, the ARIB connector 152 of the electronic device 100 has the ground terminal 161, the power feed terminal 165, and the ground terminal 170. The power feed terminal 165 is connected to the power supply input terminal PS of the power supply circuit 120, and is not connected to the detection unit 130. The cable connector detecting terminal 166 of FIG. 3 is not used.

Like in the case of FIG. 4, the cradle 220 has the ground terminal 261, the power feed terminal 265, the ground terminal 270, the contact terminals 222 and 223, and the permanent magnet 225.

Like in the case of FIG. 4, the cradle terminal unit 154 of the electronic device has the contact terminals 175 and 180 and the magnetic sensor 155. The magnetic sensor 155 has a detection terminal connected to the detection unit 130 of the power supply circuit 120. The contact terminal 175 for power feeding is connected to the power supply input terminal PS of the charge and discharge unit 124 of the power supply circuit 120.

It is assumed that the cable connector 232 of the AC/DC conversion adapter 202 is directly connected to the ARIB connector 152 of the electronic device 100 when the amount of remaining electric energy of the rechargeable battery unit 140 is not 100% and is less than a first minimum proportion Pmin1 (for example, 90%, 85%, or 80%) of the maximum chargeable capacity. Then, the detection unit 130 of the power supply circuit 120 detects no detection signal (H) of the permanent magnet 225 from the magnetic sensor 155 and provides the charge control unit 122 with a detection signal (L) indicating the absence of the connection of the cradle 220. The detection unit 130 or the charge and discharge unit 124 further detects a supply voltage (for example, 5.4 V) from the power feed terminal 165 at the power supply input terminal PS and provides the charge control unit 122 with a signal (H) indicating the presence of a charging voltage.

The charge control unit 122 of the power supply circuit 120 determines, in response to no detection of the connection of the cradle 220 and detection of the presence of a charging voltage, that the AC/DC conversion adapter 202 has been directly connected to the ARIB connector 152 of the electronic device 100.

In accordance with the determination, the charge control unit 122 causes the charge and discharge unit 124 to charge the rechargeable battery unit 140 up to a first maximum proportion Pmax1 of the maximum chargeable capacity. Thereafter, irrespective of the presence or absence of the connection of the electronic device 100 and the cable connector 232, the charge control unit 122 stops charging and prevents charging from being started until the amount of remaining electric energy of the rechargeable battery unit 140 is reduced to the first minimum proportion Pmin1 of the maximum chargeable capacity. This makes it possible to prevent the rechargeable battery unit 140 from being fully charged frequently, so that it is possible to prolong the useful service life of the rechargeable battery unit 140. As an alternative configuration, instead of setting the first minimum proportion Pmin1, the rechargeable battery unit 140 may be charged as much as possible in response to even a slight drop in the amount of remaining electric energy of the rechargeable battery unit 140 from its full level as usual.

On the other hand, it is assumed that the AC/DC conversion adapter 202 is connected to the cradle 220 and the electronic device 100 is placed in the cradle 220 so that the contact terminals 222 and 223 of the cradle 220 contact and connect to the contact terminals 175 and 180, respectively, of the cradle terminal unit 154 of the electronic device 100 when the amount of remaining electric energy of the rechargeable battery unit 140 is not 100% and is less than a second minimum proportion Pmin2 (for example, 80%) of the maximum chargeable capacity. Then, the power supply circuit 120 operates the same as in the case of FIG. 4. As a result, it is possible to prevent the rechargeable battery unit 140 from being fully charged, so that it is possible to prolong the useful service life of the rechargeable battery unit 140.

### [d] Fourth Embodiment

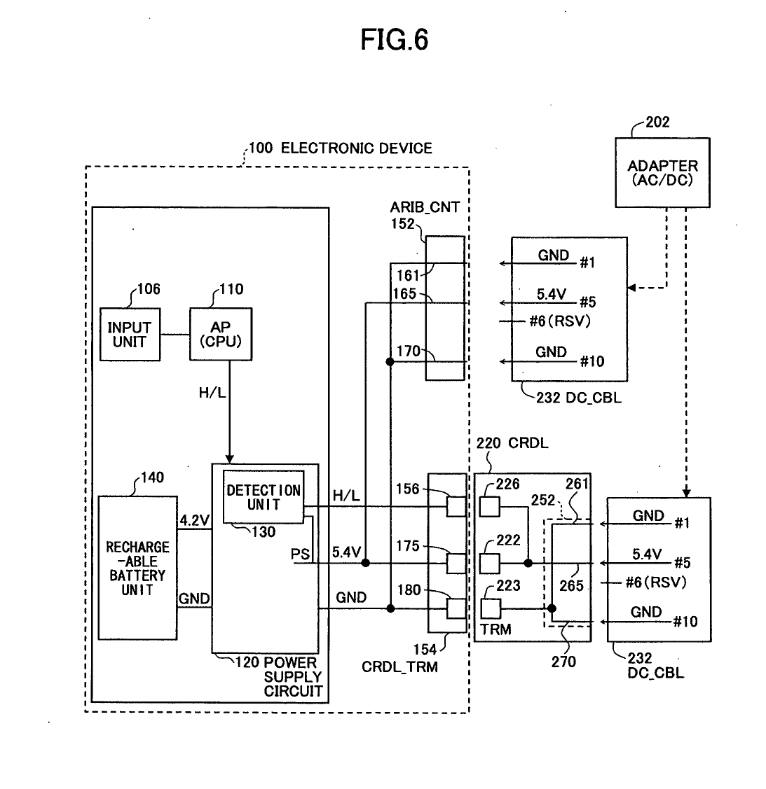

FIG. 6 is a diagram illustrating two different kinds of possible modes of connection between the power supply circuit 120 in the electronic device 100 and the AC/DC conversion adapter 202 according to a fourth embodiment, which is another variation of the embodiment illustrated in FIG. 3 or FIG. 5.

The cable connector 232 of the AC/DC conversion adapter 202 has the same configuration as in the case of FIG. 5.

In addition to the ground terminal 261, the power feed terminal 265, the ground terminal 270, and the contact terminals 222 and 223, which are the same as in the case of FIG. 3, the cradle 220 has (in place of the permanent magnet 225 of FIG. 5) a terminal contact terminal 226 configured to indicate the presence of the cradle 220 and connected to the power feed terminal 265 to be connected to Power Feed Terminal #5 of the cable connector 232.

In addition to the contact terminal 175 and the contact terminal 180, the cradle terminal unit 154 of the electronic device 100 has a contact terminal 156 for detecting the presence or absence of voltage at the contact terminal 226 of the cradle 220 in an active state (a state where the cradle 220 is enabled to feed power). The contact terminal 156 is connected to the detection unit 130 of the power supply circuit 120. The contact terminal 175 for power feeding is connected to the power supply input terminal PS of the charge and discharge unit 124 of the power supply circuit 120.

It is assumed that the cable connector 232 of the AC/DC conversion adapter 202 is directly connected to the ARIB connector 152 of the electronic device 100 when the amount of remaining electric energy of the rechargeable battery unit 140 is not 100% and is less than a first minimum proportion Pmin1 (for example, 90%, 85%, or 80%) of the maximum chargeable capacity. Then, the detection unit 130 of the power supply circuit 120 detects no high voltage level H (5.4 V) from the contact terminal 156 and provides the charge control unit 122 with a detection signal (L) indicating the absence of the connection of the cradle 220. The detection unit 130 or the charge and discharge unit 124 further detects a supply voltage (for example, 5.4 V) from the power feed terminal 165 at the power supply input terminal PS and provides the charge control unit 122 with a signal (H) indicating the presence of a charging voltage.

The charge control unit 122 of the power supply circuit 120 determines, in response to no detection of the connection of the cradle 220 and detection of the presence of a charging voltage, that the AC/DC conversion adapter 202 has been directly connected to the ARIB connector 152 of the electronic device 100.

In accordance with the determination, the charge control unit 122 causes the charge and discharge unit 124 to charge the rechargeable battery unit 140 up to a first maximum proportion Pmax1 of the maximum chargeable capacity. Thereafter, irrespective of the presence or absence of the connection of the electronic device 100 and the cable connector 232, the charge control unit 122 stops charging and prevents charging from being started until the amount of remaining electric energy of the rechargeable battery unit 140 is reduced to the first minimum proportion Pmin1 of the maximum chargeable capacity. This makes it possible to prevent the rechargeable battery unit 140 from being fully charged frequently, so that it is possible to prolong the useful service life of the rechargeable battery unit 140. As an alternative configuration, instead of setting the first minimum proportion Pmin1, the rechargeable battery unit 140 may be charged as much as possible in response to even a slight drop in the amount of remaining electric energy of the rechargeable battery unit 140 from its full level as usual.

On the other hand, it is assumed that the AC/DC conversion adapter 202 is connected to the cradle 220 and the electronic device 100 is placed in the cradle 220 so that the contact terminals 222 and 223 of the cradle 220 contact and connect to the contact terminals 175 and 180, respectively, of the cradle terminal unit 154 of the electronic device 100 when the amount of remaining electric energy of the rechargeable battery unit 140 is not 100% and is less than a second minimum proportion Pmin2 (for example, 80%) of the maximum chargeable capacity. Then, the detection unit 130 of the power supply circuit 120 detects a detection signal of a high voltage level H (5.4 V) from the contact terminal 156, indicating the presence of the connection of the cradle 220, and provides the charge control unit 122 with a detection signal (H) indicating the connection of the cradle 220. The detection unit 130 or the charge and discharge unit 124 may further detect a supply voltage (for example, 5.4 V) from the power feed terminal 175 at the power supply input terminal PS and provide the charge control unit 122 with a signal (H) indicating the presence of a charging voltage.

The charge control unit 122 of the power supply circuit 120 determines, in response to detection of the connection of the cradle 220 and/or detection of the presence of a charging voltage, that the cradle 220 has been put in contact with and connected to the cradle terminal unit 154 of the electronic device 100.

In accordance with this determination, the charge control unit 122 causes the charge and discharge unit 124 to charge the rechargeable battery unit 140 up to a second maximum proportion Pmax2 (for example, 80%) of the maximum chargeable capacity. Thereafter, irrespective of the presence or absence of the connection of the electronic device 100 and the cradle 220, the charge control unit 122 stops charging and prevents charging from being started until the amount of remaining electric energy of the rechargeable battery unit 140 is reduced to the second minimum proportion Pmin2 of the maximum chargeable capacity. This makes it possible to prevent the rechargeable battery unit 140 from being fully charged, so that it is possible to prolong the useful service life of the rechargeable battery unit 140.

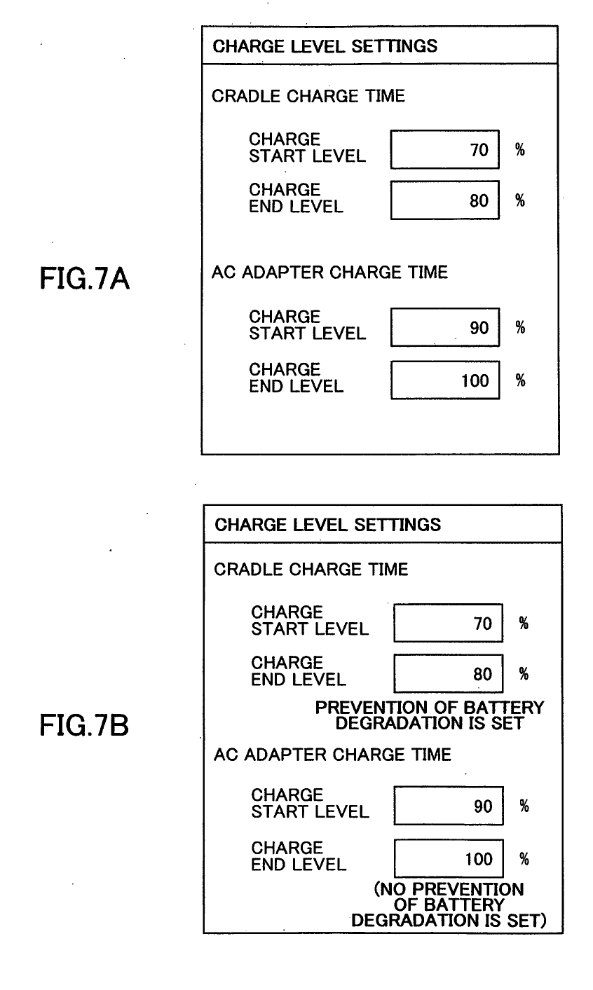

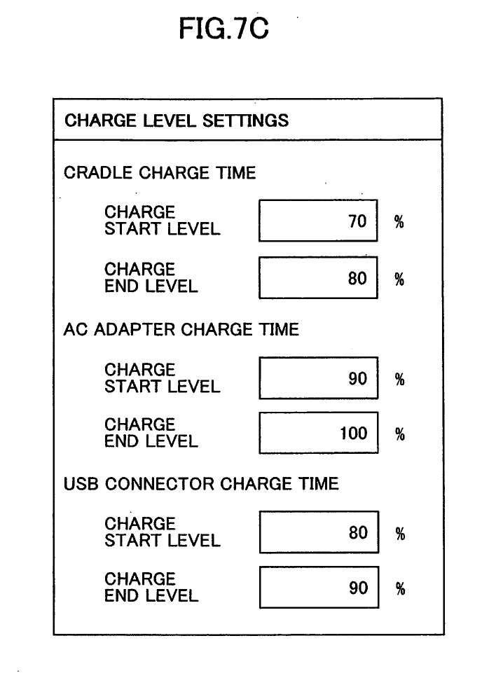

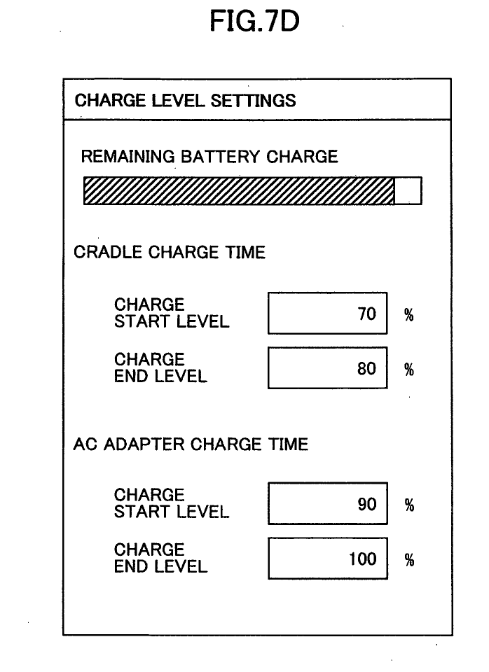

FIGS. 7A through 7D are diagrams illustrating charge level setting screens (for setting charge level) displayed on the display unit 108 (FIG. 1) of the electronic device 100.

By activating a charge level setting function in the application 110 (FIG. 1) in the electronic device 100, a user may set a minimum charge level Pmin and a maximum charge level Pmax in each charge mode.

On the charge level setting screen of FIG. 7A, it is possible to set the charge start level Pmin (%) and the charge end level Pmax (%) of the electronic device 100 in the case of charging the electronic device 100 using the cradle 220. Further, on the same screen, it is possible to set the charge start level Pmin (%) and the charge end level Pmax (%) of the electronic device 100 in the case of charging the electronic device 100 by directly connecting the AC/DC conversion adapter 202 to the electronic device 100.

The charge level setting screen of FIG. 7B illustrates the case of additionally displaying information indicating whether the set charge levels prevent degradation of the rechargeable battery unit 140 on the screen of FIG. 7A. For example, a message “NO PREVENTION OF RECHARGEABLE BATTERY DEGRADATION IS SET” may be displayed in the case of a charge end level higher than or equal to, for example, 96% (100% in the case of FIG. 7B), and a message “PREVENTION OF RECHARGEABLE BATTERY DEGRADATION IS SET” may be displayed in the case of a charge end level lower than or equal to, for example, 95%, typically 90%.

On the charge level setting screen of FIG. 7C, in addition to the levels set in FIG. 7A, it is possible to set the charge start level Pmin (%) and the charge end level Pmax (%) of the electronic device 100 in the case of charging the electronic device 100 by connecting the USB connector 236 to the electronic device 100.

On the charge level setting screen of FIG. 7D, in addition to the setting of FIG. 7A, it is possible to display a present amount of remaining electric energy with a bar graph.

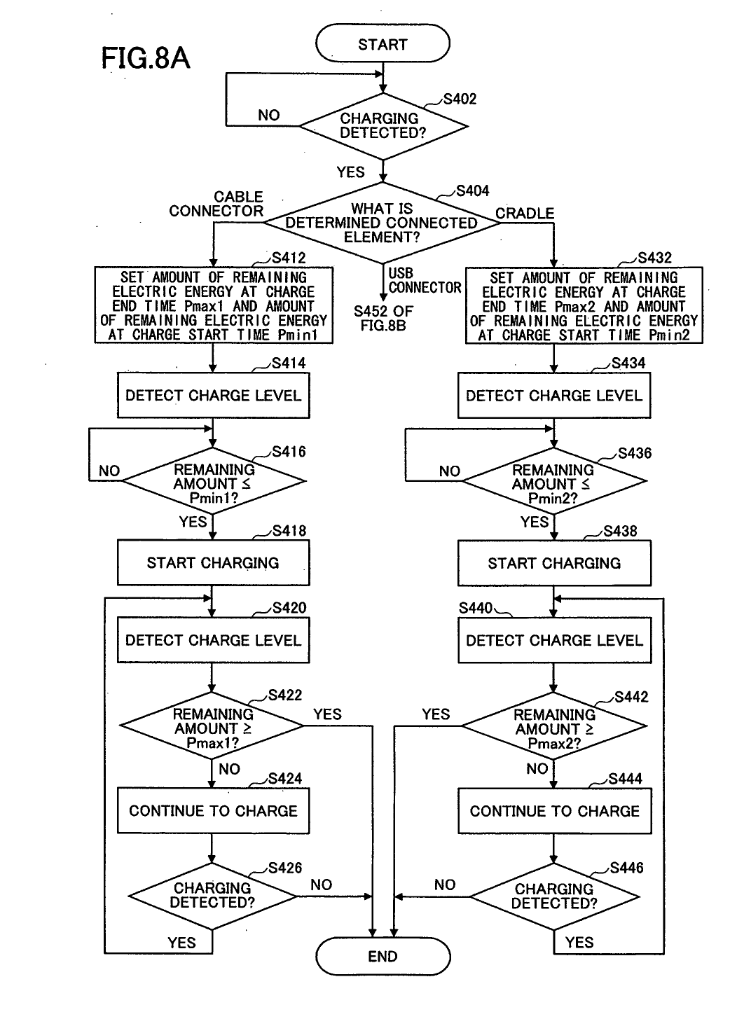

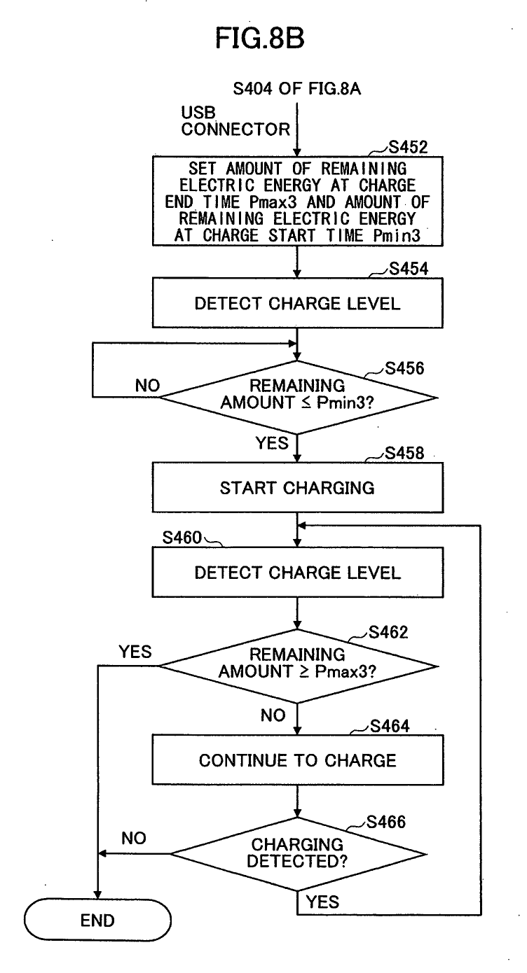

FIGS. 8A and 8B are flowcharts illustrating charge control executed by the charge control unit 122 of the power supply circuit 120.

Referring to FIG. 8A, in step S402, the charge control unit 122 of the power supply circuit 120 determines whether the charge control unit 122 has detected a charging voltage from the charge and discharge control unit 124 (the voltage and current detecting unit 145). If it is determined that no charging voltage has been detected (NO in step S402), step S402 is repeated until a charging voltage is detected. If it is determined that a charging voltage has been detected (YES in step S402), the process proceeds to step S404.

In step S404, the charge control unit 122 determines which one of the cable connector 232, the cradle 220, and, in the case of the configuration of FIG. 4, the USB connector 236 the connected element determined to have been connected to the electronic device 100 is. If it is determined in step S404 that the cable connector 232 has been connected to the electronic device 100, the process proceeds to step S412. If it is determined in step S404 that the cradle 220 has been connected to the electronic device 100, the process proceeds to step S432. If it is determined in step S404 that the USB connector 236 has been connected to the electronic device 100, the process proceeds to step S452 of FIG. 8B.

In step S412, the charge control unit 122 determines (sets) the amount of remaining electric energy at the end of charging (a maximum proportion) Pmax1 (for example, 100%) and the amount of remaining electric energy at the start of charging (a minimum proportion) Pmin1 (for example, 90%) corresponding to charging with the cable connector 232 as thresholds to be applied among the thresholds Pmax1 through Pmax3 and Pmin1 through Pmin3 contained in the memory 104 or the threshold storage area 123.

In step S414, the charge control unit 122 causes the remaining electric energy amount detecting unit 128 to detect the value P (Ah) or proportion P (%) of the present amount of remaining electric energy of the rechargeable battery unit 140. In step S416, the charge control unit 122 determines whether the present amount of remaining electric energy P is less than or equal to the amount of remaining electric energy at the start of charging (a minimum proportion) Pmin1. Step S416 is repeated until it is determined that the present amount of remaining electric energy P is less than or equal to the amount of remaining electric energy at the start of charging Pmin1.

If it is determined in step S416 that the present amount of remaining electric energy P is less than or equal to the amount of remaining electric energy at the start of charging Pmin1 (YES in step S416), in step S418, the charge control unit 122 causes the charge and discharge unit 124 to start charging the rechargeable battery unit 130.

In step S420, the charge control unit 122 causes the remaining electric energy amount detecting unit 128 to detect the value P (Ah) or proportion P (%) of the present amount of remaining electric energy of the rechargeable battery unit 140. In step S422, the charge control unit 122 determines whether the present amount of remaining electric energy P is more than or equal to the amount of remaining electric energy at the end of charging (a maximum proportion) Pmax1. If it is determined that the present amount of remaining electric energy P is more than or equal to the amount of remaining electric energy at the end of charging Pmax1 (YES in step S422), the process goes out of the routine of FIG. 8A to end charging.

If it is determined in step S422 that the present amount of remaining electric energy P is not more than or equal to the amount of remaining electric energy at the end of charging Pmax1 (NO in step S422), in step S424, the charge control unit 122 causes the charge and discharge unit 124 to continue to charge the rechargeable battery unit 140. In step S426, the charge control unit 122 determines whether the charge control unit 122 has detected a charging voltage from the charge and discharge unit 124 (the voltage and current detecting unit 145). If it is determined that no charging voltage has been detected (NO in step S426), the process goes out of the routine of FIG. 8A to end charging.

If a charging voltage has been detected in step S426 (YES in step S426), the process returns to step S420 to repeat steps S420 through S426 until the process goes out of the routine of FIG. 8A in step S422 or step S426.

In step S432, the charge control unit 122 determines (sets) the amount of remaining electric energy at the end of charging (a maximum proportion) Pmax2 (for example, 80%) and the amount of remaining electric energy at the start of charging (a minimum proportion) Pmin2 (for example, 70%) corresponding to charging with the cradle 220 as thresholds to be applied among the thresholds Pmax1 through Pmax3 and Pmin1 through Pmin3 contained in the memory 104 or the threshold storage area 123.

Step S434 is the same as step S414. In step S436, the charge control unit 122 determines whether the present amount of remaining electric energy P is less than or equal to the amount of remaining electric energy at the start of charging (a minimum proportion) Pmin2. Step S436 is repeated until it is determined that the present amount of remaining electric energy P is less than or equal to the amount of remaining electric energy at the start of charging Pmin2.

If it is determined in step S436 that the present amount of remaining electric energy P is less than or equal to the amount of remaining electric energy at the start of charging Pmin2 (YES in step S436), in step S438, the charge control unit 122 causes the charge and discharge unit 124 to start charging the rechargeable battery unit 130.

Step S440 is the same as step S420. In step S442, the charge control unit 122 determines whether the present amount of remaining electric energy P is more than or equal to the amount of remaining electric energy at the end of charging (a maximum proportion) Pmax2. If it is determined that the present amount of remaining electric energy P is more than or equal to the amount of remaining electric energy at the end of charging Pmax2 (YES in step S442), the process goes out of the routine of FIG. 8A to end charging.

If it is determined in step S442 that the present amount of remaining electric energy P is not more than or equal to the amount of remaining electric energy at the end of charging Pmax2 (NO in step S442), in step S444, the charge control unit 122 causes the charge and discharge unit 124 to continue to charge the rechargeable battery unit 140. Step S446 is the same as step S426.

If a charging voltage has been detected in step S446 (YES in step S446), the process returns to step S440 to repeat steps S440 through S446 until the process goes out of the routine of FIG. 8A in step S442 or step S446.

Referring to FIG. 8B, in step S452, the charge control unit 122 determines (sets) the amount of remaining electric energy at the end of charging (a maximum proportion) Pmax3 (for example, 90%) and the amount of remaining electric energy at the start of charging (a minimum proportion) Pmin3 (for example, 80%) corresponding to charging with the USB connector 236 as thresholds to be applied among the thresholds Pmax1 through Pmax3 and Pmin1 through Pmin3 contained in the memory 104 or the threshold storage area 123.

Step S454 is the same as step S414. In step S456, the charge control unit 122 determines whether the present amount of remaining electric energy P is less than or equal to the amount of remaining electric energy at the start of charging (a minimum proportion) Pmin3. Step S456 is repeated until it is determined that the present amount of remaining electric energy P is less than or equal to the amount of remaining electric energy at the start of charging Pmin3.

If it is determined in step S456 that the present amount of remaining electric energy P is less than or equal to the amount of remaining electric energy at the start of charging Pmin3 (YES in step S456), in step S458, the charge control unit 122 causes the charge and discharge unit 124 to start charging the rechargeable battery unit 130.

Step S460 is the same as step S420. In step S462, the charge control unit 122 determines whether the present amount of remaining electric energy P is more than or equal to the amount of remaining electric energy at the end of charging (a maximum proportion) Pmax3. If it is determined that the present amount of remaining electric energy P is more than or equal to the amount of remaining electric energy at the end of charging Pmax3 (YES in step S462), the process goes out of the routine of FIG. 8A to end charging.

If it is determined in step S462 that the present amount of remaining electric energy P is not more than or equal to the amount of remaining electric energy at the end of charging Pmax3 (NO in step S462), in step S464, the charge control unit 122 causes the charge and discharge unit 124 to continue to charge the rechargeable battery unit 140. Step S466 is the same as step S426.

If a charging voltage has been detected in step S466 (YES in step S466), the process returns to step S460 to repeat steps S460 through S466 until the process goes out of the routine of FIG. 8B in step S462 or step S466.

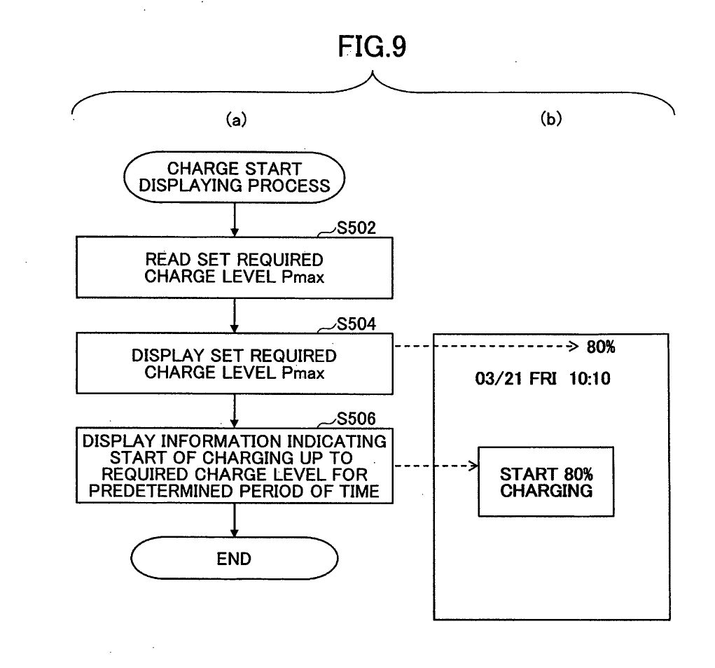

Referring to FIG. 9, (a) illustrates a flowchart of a display operation in the display unit 108 at the start of charging, which is executed by the CPU 102 of the electronic device 100 in accordance with a power supply managing function in the application 110 (FIG. 1). This display operation starts in response to (or is triggered by) execution of step S418 in FIG. 8A, step S438 in FIG. 8A, or step S458 in FIG. 8B (the start of charging).

In FIG. 9, (b) illustrates a screen displayed on the display unit 108 in the display operation of (a) of FIG. 9.

Referring to (a) of FIG. 9, in step S502, the CPU 102 reads a set required maximum charge level (amount) or proportion Pmax from among the maximum charge levels Pmax1 through Pmax3 contained in the memory 104 or the threshold storage area 123 of the charge control unit 122. In step S504, the CPU 102 displays the read required maximum charge level or proportion Pmax (for example, 80%) together with an icon (such as a picture of an outlet or plug) indicating that charging is in process at a predetermined position on the display screen of the display unit 108 as illustrated in (b) of FIG. 9. This allows a user to be notified of a current required charge level.

In step S506, the CPU 102 displays a message indicating the start of charging up to the required maximum charge level or proportion Pmax at a predetermined position on the display screen of the display unit 108 as illustrated in (b) of FIG. 9 for a predetermined period of time (for example, 5 seconds). This allows a user to have a strong recognition of a current required charge level.

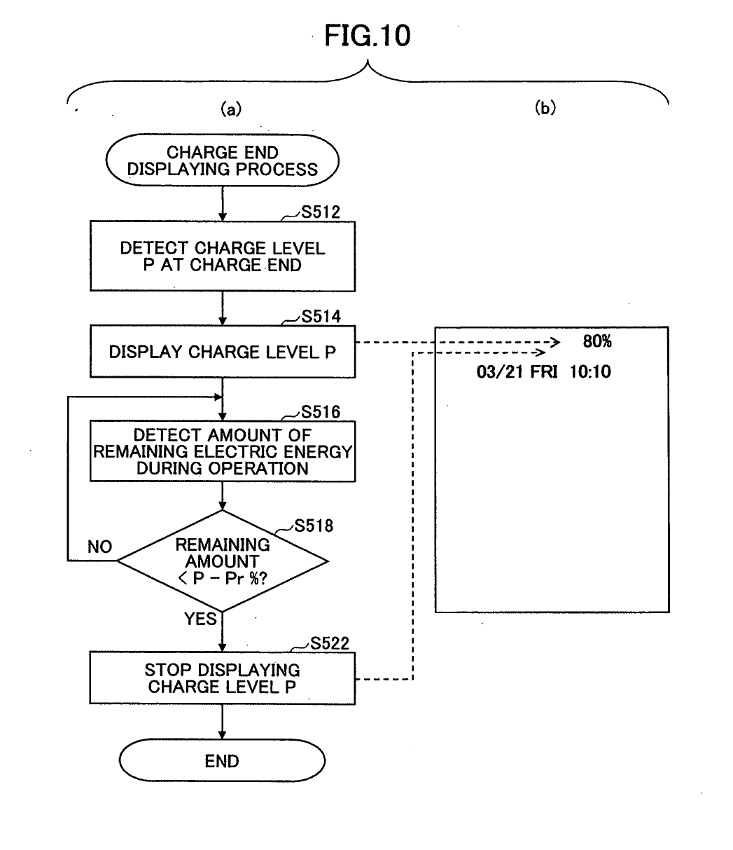

Referring to FIG. 10, (a) illustrates a flowchart of a display operation in the display unit 108 at the end of charging, which is executed by the CPU 102 of the electronic device 100 in accordance with the power supply managing function in the application 110 (FIG. 1). This display operation starts in response to (or is triggered by) the end of the routine in FIG. 8A or FIG. 8B (the end of charging).

In FIG. 10, (b) illustrates a screen displayed on the display unit 108 in the display operation of (a) of FIG. 10.

Referring to (a) of FIG. 10, in step S512, the CPU 102 causes the remaining electric energy detecting unit 128, via the charge control unit 122, to detect the amount of remaining electric energy at the end of charging as a charge level (amount) or proportion P (for example, Pmax), and reads the charge level or proportion. In step S514, the CPU 102 displays the charge level P (for example, 80%) at a predetermined position on the display screen of the display unit 108 as illustrated in (b) of FIG. 10.

In step S516, the CPU 102 causes the remaining electric energy detecting unit 128, via the charge control unit 122, to detect the amount of remaining electric energy as a charge level (amount) or proportion, and reads the charge level or proportion.

In step S518, the CPU 102 determines whether the detected present amount of remaining electric energy is less than the difference between the charge level (amount) P at the end of charging and a predetermined level (amount) Pr (for example, 10%) (P−Pr [%]). That is, the CPU 102 determines whether the detected present amount of remaining electric energy is reduced from the charge level P at the end of charging by more than the predetermined level Pr. If it is determined that the detected present amount of remaining electric energy is less than (the charge level P at the end of charging−the predetermined level Pr) (P−Pr) (YES in step S518), the process proceeds to step S522. Steps S516 through 518 are repeated until it is determined in step S518 that the detected present amount of remaining electric energy is less than (the charge level P at the end of charging−the predetermined level Pr) (P−Pr).

In step S522, the CPU 102 stops displaying the charge level P at the end of charging, thereby preventing excessive information from being displayed to reduce power consumption.

For example, it is assumed that a user frequently places the electronic device 100 as a cellular phone in the cradle 220 when not using the electronic device 100 and removes the electronic device 100 from the cradle 220 to use the electronic device 100 in a short period of time. In such a situation, conventionally, the rechargeable battery unit 140 of the electronic device 100 frequently repeats charging and discharging between a fully-charged state and a state where the rechargeable battery unit 140 is slightly less charged than in the fully-charged state. This causes relatively large reduction in the maximum chargeable capacity of the rechargeable battery 141 of the rechargeable battery unit 140 in a relatively short period of time, so that the useful service life of the rechargeable battery 141 is reduced. However, according to the above-described embodiments, even in such a situation, it is possible to provide such a setting that the rechargeable battery unit 140 of the electronic device 100 is charged, at most, only up to a level sufficiently lower than its fully-charged state (level). This makes it possible to prevent reduction or reduce the rate of reduction in the maximum chargeable capacity of the rechargeable battery 141 of the rechargeable battery unit 140, so that it is possible to prolong the useful service life of the rechargeable battery 141.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A charging circuit configured to charge a rechargeable battery, comprising:
an input unit configured to support a plurality of forms of connection to an external power supply and to receive electric power supplied from the external power supply;
a charge unit configured to supply the rechargeable battery with the electric power supplied from the input unit;
a detection unit configured to detect a charge level of the rechargeable battery; and
a charge control unit configured to control the charge unit so as to prevent the rechargeable battery from being supplied with the electric power supplied from the input unit supplied with the electric power from the external power supply through one of the forms of connection to the external power supply, in response to the charge level detected by the detection unit exceeding a threshold corresponding to said one of the forms of connection.

2. The charging circuit as claimed in claim 1, wherein:
the input unit includes
a first input unit configured to receive the electric power from the external power supply through a first one of the forms of connection; and
a second input unit configured to receive the electric power from the external power supply through a second one of the forms of connection, and
the charge control unit is configured to control the charge unit so as to prevent the rechargeable battery from being supplied with the electric power supplied from the first input unit, in response to the charge level detected by the detection unit exceeding a first threshold corresponding to the first input unit, and to control the charge unit so as to prevent the rechargeable battery from being supplied with the electric power supplied from the second input unit, in response to the charge level detected by the detection unit exceeding a second threshold corresponding to the second input unit.

3. The charging circuit as claimed in claim 2, wherein:
the first input unit is configured to receive the electric power supplied from the external power supply through a connection to a power feed connector configured to supply the electric power supplied from the external power supply,
the second input unit is configured to receive the electric power supplied from the external power supply through a connection to a connecting part of a stand upon placement of an electronic device including the charging circuit on the stand, the stand being configured to supply the electric power supplied from the external power supply, and
the second threshold corresponding to the second input unit is lower than the first threshold corresponding to the first input unit.

4. The charging circuit as claimed in claim 1, further comprising:
a storage unit configured to store control information including the forms of connection and respective thresholds thereof for the charge level of the rechargeable battery; and
a connection form identifying unit configured to identify the one of the forms of connection between the external power supply and the input unit,
wherein the charge control unit is configured to obtain the threshold corresponding to the one of the forms of connection identified by the connection form identifying unit from the control information stored by the storage unit.

5. An electronic device, comprising:
an input unit configured to support a plurality of forms of connection to an external power supply and to receive electric power supplied from the external power supply;
a charge unit configured to supply a rechargeable battery with the electric power supplied from the input unit, the rechargeable battery being used as a power supply for the electronic device;
a detection unit configured to detect a charge level of the rechargeable battery; and
a charge control unit configured to control the charge unit so as to prevent the rechargeable battery from being supplied with the electric power supplied from the input unit supplied with the electric power from the external power supply through one of the forms of connection to the external power supply, in response to the charge level detected by the detection unit exceeding a threshold corresponding to said one of the forms of connection.

6. The electronic device as claimed in claim 5, wherein:
the input unit includes
a first input unit configured to receive the electric power from the external power supply through a first one of the forms of connection; and
a second input unit configured to receive the electric power from the external power supply through a second one of the forms of connection, and
the charge control unit is configured to control the charge unit so as to prevent the rechargeable battery from being supplied with the electric power supplied from the first input unit, in response to the charge level detected by the detection unit exceeding a first threshold corresponding to the first input unit, and to control the charge unit so as to prevent the rechargeable battery from being supplied with the electric power supplied from the second input unit, in response to the charge level detected by the detection unit exceeding a second threshold corresponding to the second input unit.

7. The electronic device as claimed in claim 6, wherein:
the first input unit is configured to receive the electric power supplied from the external power supply through a connection to a power feed connector configured to supply the electric power supplied from the external power supply,
the second input unit is configured to receive the electric power supplied from the external power supply through a connection to a connecting part of a stand upon placement of the electronic device on the stand, the stand being configured to supply the electric power supplied from the external power supply, and
the second threshold corresponding to the second input unit is lower than the first threshold corresponding to the first input unit.

8. The electronic device as claimed in claim 5, further comprising:
a storage unit configured to store control information including the forms of connection and respective thresholds thereof for the charge level of the rechargeable battery; and
a connection form identifying unit configured to identify the one of the forms of connection between the external power supply and the input unit,
wherein the charge control unit is configured to obtain the threshold corresponding to the one of the forms of connection identified by the connection form identifying unit from the control information stored by the storage unit.

9. A method of charging a rechargeable battery configured to be used as a power supply for an electronic device including an input unit configured to support a plurality of forms of connection to an external power supply and to receive electric power supplied from the external power supply, the method comprising:
detecting a charge level of the rechargeable battery; and
preventing the rechargeable battery from being supplied with electric power supplied from the input unit supplied with the electric power from the external power supply through one of the forms of connection to the external power supply, in response to the charge level detected by said detecting exceeding a threshold corresponding to said one of the forms of connection.

10. The method as claimed in claim 9, wherein:
the input unit includes
a first input unit configured to receive the electric power from the external power supply through a first one of the forms of connection; and
a second input unit configured to receive the electric power from the external power supply through a second one of the forms of connection, and
said preventing prevents the rechargeable battery from being supplied with the electric power supplied from the first input unit, in response to the charge level detected by said detecting exceeding a first threshold corresponding to the first input unit, and to control the charge unit so as to prevent the rechargeable battery from being supplied with the electric power supplied from the second input unit, in response to the charge level detected by said detecting exceeding a second threshold corresponding to the second input unit.

11. The method as claimed in claim 10, wherein:
the first input unit is configured to receive the electric power supplied from the external power supply through a connection to a power feed connector configured to supply the electric power supplied from the external power supply,
the second input unit is configured to receive the electric power supplied from the external power supply through a connection to a connecting part of a stand upon placement of the electronic device on the stand, the stand being configured to supply the electric power supplied from the external power supply, and
the second threshold corresponding to the second input unit is lower than the first threshold corresponding to the first input unit.

12. The method as claimed in claim 9, further comprising:
identifying the one of the forms of connection between the external power supply and the input unit,
wherein said preventing obtains the threshold corresponding to the one of the forms of connection identified by said identifying from a storage unit prestoring control information including the forms of connection and respective thresholds thereof for the charge level of the rechargeable battery, and determines whether the charge level detected by said detecting exceeds the threshold corresponding to said one of the forms of connection using the charge level detected by said detecting and the obtained threshold.

13. A power supply unit, comprising:
a charge storage unit configured to receive electric power supplied from an external power supply and store an electric charge;
an input unit configured to support a plurality of forms of connection to the external power supply and to receive the electric power supplied from the external power supply;
a charge unit configured to supply the charge storage unit with the electric power supplied from the input unit;
a detection unit configured to detect a charge level of the charge storage unit; and
a charge control unit configured to control the charge unit so as to prevent the charge storage unit from being supplied with the electric power supplied from the input unit supplied with the electric power from the external power supply through one of the forms of connection to the external power supply, in response to the charge level detected by the detection unit exceeding a threshold corresponding to said one of the forms of connection.

14. The power supply unit as claimed in claim 13, wherein:
the input unit includes
a first input unit configured to receive the electric power from the external power supply through a first one of the forms of connection; and
a second input unit configured to receive the electric power from the external power supply through a second one of the forms of connection, and
the charge control unit is configured to control the charge unit so as to prevent the charge storage unit from being supplied with the electric power supplied from the first input unit, in response to the charge level detected by the detection unit exceeding a first threshold corresponding to the first input unit, and to control the charge unit so as to prevent the charge storage unit from being supplied with the electric power supplied from the second input unit, in response to the charge level detected by the detection unit exceeding a second threshold corresponding to the second input unit.

15. The power supply unit as claimed in claim 14, wherein:
the first input unit is configured to receive the electric power supplied from the external power supply through a connection to a power feed connector configured to supply the electric power supplied from the external power supply,
the second input unit is configured to receive the electric power supplied from the external power supply through a connection to a connecting part of a stand upon placement of the power supply unit on the stand, the stand being configured to supply the electric power supplied from the external power supply, and
the second threshold corresponding to the second input unit is lower than the first threshold corresponding to the first input unit.

16. The power supply unit as claimed in claim 13, further comprising:
a storage unit configured to store control information including the forms of connection and respective thresholds thereof for the charge level of the charge storage unit; and
a connection form identifying unit configured to identify the one of the forms of connection between the external power supply and the input unit,
wherein the charge control unit is configured to obtain the threshold corresponding to the one of the forms of connection identified by the connection form identifying unit from the control information stored by the storage unit.
